(19) United States
(12) Patent Application Publication
(10) Pub. No.: US 2025/0153140 A1
(43) Pub. Date: May 15, 2025

(54) A FUNCTIONALISED CHROMATOGRAPHY MEDIUM LACKING SURFACE EXTENDER

(71) Applicant: Cytiva BioProcess R&D AB, Uppsala (SE)

(72) Inventors: Jean-Luc Maloisel, Uppsala (SE); Frederic Leroux, Stevenage Hertfordshire (GB); Lisa Marx, Uppsala (SE)

(21) Appl. No.: 18/839,374

(22) PCT Filed: Feb. 16, 2023
(86) PCT No.: PCT/EP2023/053847

§ 371 Date: Aug. 16, 2024

(30) Foreign Application Priority Data
Feb. 28, 2022 (GB) 2202713.0

(51) Int. Cl. B01J 20/289; B01D 15/36; B01D 15/38; B01J 20/24; B01J 20/26; B01J 20/28; B01J 20/32

(52) U.S. Cl. CPC B01J 20/289; B01D 15/362; B01D 15/363; B01D 15/3804; B01D 15/3847; B01J 20/24; B01J 20/267; B01J 20/28085; B01J 20/3208; B01J 20/3219; B01J 20/3248; B01J 20/3293

(57) ABSTRACT

A chromatography medium is provided, comprising a matrix of cellulose-based nanofibers, the nanofibers optionally being crosslinked to one another. A ligand coupled to the matrix without any intermediate extender group. Also provided is a method of preparing a functionalised chromatography medium. The method comprises: (i) providing a substrate comprising cellulose acetate; (ii) forming a fibrous matrix/membrane spun of nanofibers from the substrate; (iii) saponification of the nanofibers to form regenerated cellulose nanofibers; (iv) derivatisation of the regenerated cellulose nanofibers with a cross-linker, and (v) coupling of a ligand to the derivatised cellulose nanofibers, wherein the preparation of the functionalised chromatography medium does not comprise any surface extender. The chromatography medium is useful for separation of large analytes, such as viruses.

### TECHNICAL FIELD

The present disclosure relates to a chromatography medium and use thereof, a method of preparing a functionalised chromatography medium and to processes of separating an analyte in solution using such functionalised chromatography medium.

### BACKGROUND ART

In chromatographic purification highly porous microscale beads are commonly used. These beads have a functionalized surface to allow discrimination of for example a drug product from the complex process stream. With a protein A ligand on the bead surface, monoclonal antibody (mAb) purification may be mediated via an affinity interaction.

An alternative to porous beads is for example used in the HiTrap Fibro unit from Cytiva. The fibro material is a non-woven fibrous material, such as from cellulose acetate. The fibro material uses a proprietary structure that overcomes the diffusional and flow limitations of packed bed chromatography purification systems. It also aims to address capacity issues of chromatography membranes, which are mostly limited to contaminant capture steps. The Fibro material has the potential to improve process flexibility and robustness, while meeting the demands of the rapidly changing biopharma landscape.

The cellulose acetate-based fibro membrane absorber is an extraordinary productive chromatographic format allowing residence time of a few seconds (^{˜}3 sec) while retaining a good binding capacity. This is to a large extent due to a very porous structure, with a surface that is extended via a polymeric polyol based on glycidol. The use of glycidol together with divinyl sulfone is for the moment inherent to the fibro platform since it has been shown to be necessary to obtain good binding of protein A for mAbs applications and is the common intermediate used for the next generation of products.

Glycidol is, however, a substance that is classified as carcinogenic, mutagenic, or toxic for reproduction (CMR) and as such its use should be decreased or avoided when possible.

### SUMMARY OF THE INVENTION

It is an object of the present disclosure to provide a method for preparing a functionalised fibro material that secures a good analyte binding capacity without using glycidol in the functionalisation of the material.

The invention is defined by the appended independent patent claims. Non-limiting embodiments emerge from the dependent patent claims, the appended drawings and the following description.

In one aspect of the invention there is provided a chromatography medium comprising a matrix of cellulose-based nanofibers, the nanofibers optionally being crosslinked to one another, and a ligand is coupled to the matrix without any intermediate extender group.

The ligand may be coupled to the nanofibers of the matrix via a linking group comprising less than 10 repeating moieties, or which may be non-polymeric. In embodiments, the linking group may contain no more than 20 atoms. The linking group may be selected from a vinyl sulfone moiety and an alkyne or allyl derivative.

The matrix may have a mean flow pore size in the range of from 0.1-2.0 μm. Advantageously, the matrix may allow convective flow of a fluid through the matrix.

Crosslinks may be formed between said nanofibers. The crosslinks may be provided by a crosslinking agent selected from the group consisting of divinyl sulfone, bis acrylamide, butanediol diglycidyl ether, epichlorohydrin, allyl glycidyl ether, allyl bromide, 1,4-dibromo butane and bismaleimide.

In another aspect the invention provides use of such a chromatography medium for separation of an analyte selected from the group consisting of mRNA, viruses (including viral vectors), virus-like particles, plasmids, and extracellular vesicles.

According to a another aspect there is provided a method of preparing a functionalised chromatography medium, which method comprises:
(i) providing a substrate comprising cellulose acetate; (ii) forming a fibrous matrix/membrane spun of nanofibers from the substrate; (iii) saponification of the nanofibers to form regenerated cellulose nanofibers; (iv) derivatisation of the regenerated cellulose nanofibers with a cross-linker, and (v) coupling of a ligand to the derivatised cellulose nanofibers, wherein the preparation of the functionalised chromatography medium does not comprise any surface extender.

Cellulose acetate (CA) is the acetate ester of cellulose produced from cellulose via the process of acetylation.

Electrospinning may be used to form CA nanofibers. A matrix of such CA nanofibers forms a fibrous matrix or membrane. Such methods are well-known in the art.

It is known in the art to functionalise cellulose acetate-based material using an extender group, glycidol, together with e.g. divinyl sulfone. Such functionalisation has been shown to give satisfactory binding of protein A to a fibrous matrix for mAbs applications. Glycidol is, however, a substance that is classified as carcinogenic, mutagenic, or toxic for reproduction (CMR) and as such its use should be decreased or avoided when possible.

The method outlined above for functionalising cellulose acetate-based fibro material is a method in which no extender group, such as glycidol, is used. The ligand is directly coupled to the derivatised cellulose nanofibers without using an extender group.

As used herein, the term “analyte” denotes a substance to be separated by means of a chromatography process. Sometimes, where the analyte to be separated is an entity of interest intended to be purified, it may be referred to as “target” or “target entity”. The expression “large targets” typically refers to entities that are significantly larger than antibodies, for instance entities having a diameter of at least 20 nm. For reference, monoclonal antibodies typically have a size of about 5 nm. Examples of large targets include mRNA, viruses (such as AAV, adenoviruses, lentiviruses and other enveloped viruses) and virus-based vectors, virus-like particles, plasmids, and extracellular vesicles such as exosomes.

The present inventors have found that in some cases the functionalized chromatography medium does not require an extender for coupling the ligand to the matrix. Surprisingly, it was shown that a good binding capacity for large targets, such as mRNA, viruses, plasmids etc. could be achieved using a functionalized chromatography medium prepared as described herein, without any extender group.

The previously used glycidol polymerisation results in branching of the formed polymer chain, yielding a “bush” structure. Thus, typically, one or more of the polymer chains is branched and may well be hyperbranched. The different types of monomer residues in a glycidol polymer are: glycerol triether (branch point), 1,2- or 1,3-glycerol diether (linear) and 1- or 2-glycerol monoether (terminal). In many cases, the triether and monoether residues dominate, producing a hyperbranched polymer. Such a hyperbranched polymer chain may comprise at least 20 repeating moities. In contrast, the functionalized chromatography medium disclosed herein typically lacks hyperbranched structures, and may also lack branched structures. Further, the functionalized chromatography medium disclosed herein may lack the glycerol mono-, di- and tri-ethers mentioned above.

Another advantage observed with the chromatography medium described herein is that the flow properties of the medium may be improved, especially in applications with larger targets. Not wishing to be bound by theory, it is believed that with increasing target size, it becomes more difficult for the target entities to move freely in the support. Here, the absence of surface extenders may be beneficial, as the porosity of the support is not reduced by the extenders filling up part of the volume between the nanofibers. For large targets, a high porosity is preferred, as this allows higher flow rates without buildup of undesirably high back pressure. A high back pressure can be particularly detrimental for sensitive target entities like viruses, plasmids and extracellular vesicles, as compared to monoclonal antibodies.

ΔP (delta pressure) denotes the differential pressure over a chromatography column or bed, defined as the difference between pre-column or pre-bed pressure and post-column or post-bed pressure. In this context, the present chromatography medium may represent a column or bed. As an example, a typical ΔP of a fibrous matrix/membrane is specified below 0.5 at a flow rate of 20 ml/min. For a matrix/membrane with surface extender ΔP can normally be within the range of ΔP 0.2 to 0.4 bar for a given flow rate, e.g. 10 ml/min. Without surface extender, the ΔP may instead be in the range of 0.15-0.25 bar. There is, hence, improved flow properties and the column pressure is lower using a chromatography medium without any extender. (The numbers given being for Lenti virus application using TRIS buffer).

The cross-linker used in the present invention serves to provide cross-linking of the nanofibers of the fibrous matrix. In addition, the cross-linker also provides derivatisation of the nanofibers, which derivatisation is used for subsequent coupling of the ligand. The cross-linker may thus also be regarded as an activator that activates the matrix to enable coupling of ligands thereto. Hence, the cross-linker may be an agent that acts both as a crosslinker and an activator.

The cross-linker may comprise at least two functional groups arranged to react with hydroxyl groups of the regenerated cellulose nanofibers. The functional groups may be selected from halide, acrylamide, epoxide, tosylate, a functional group comprising a double or triple bound that is or can be activated, or any combination thereof. Examples of groups containing double or triple bonds that can be activated include vinyl, alkyne and alkene.

A functional group comprising a double bound may for example be a vinyl.

The functional groups may be selected from divinyl sulfone, bis acrylamide, butanediol diglycidyl ether, epichlorohydrin, allyl glycidyl ether, allyl bromide, 1,4-dibromo butane, bismaleimide or any combination thereof.

In one embodiment the cross-linker may be divinylsulfone.

A divinylsulfone derivatised regenerated cellulose nanofiber matrix/membrane may have a vinylsulfone content of 200-1600 μmol/g. In embodiments, the vinyl sulfone content may be 200-1200 μmol/g, 200-1000 μmol/g, or preferably 200-800 μmol/g. In other embodiments, the vinylsulfone content may be 800-1600 μmol/g, such as 800-1300 μmol/g, or 1000-1300 μmol/g.

The ligand may be coupled to the nanofiber matrix via a linker group, which may originate from the above-described saponification and derivatisation using a crosslinker, such as divinyl sulfone. The linker group is typically smaller than a surface extender obtained by glycidol polymerisation. As mentioned above, a surface extender provided by the polymerisation of glycidol may result in a branched polymer having at least 20 repeating moieties per branched polymer. In contrast, the linker group used in the present invention may for example contain no more than 20 atoms, such as no more than 10 atoms. Typically, the linker does not contain repeating moieties, or at least substantially fewer than 20 repeating moieties, such as 10 repeating moieties or less, such as 5 or less, such as at most 2 repeating moieties. For example, using divinyl sulfone as the linker, the linker group may contain no more than 8 backbone atoms. As used herein, the terms “extender”, “surface extender” and “extender group” refers to a polymeric structure of repeating moieties connecting a ligand to a support, such as the chromatography base matrix. Accordingly, the expressions “without a surface extender”, “without any intermediate extender group”, “lacking a surface extender” and the like, are intended to mean that the coupling of the ligand to the matrix (in this case, nanofibers) is made without the use of a polymeric structure. “Intermediate” refers to the location between the matrix and the ligand. Instead, the coupling of the ligand may be provided by a linking group that is substantially smaller than a surface extender, and that typically is not formed of repeating moieties. Hence, the linker group may be non-polymeric, meaning that it does not form a polymeric structure. For example, the coupling may be provided by a linker that contains no more than 20 atoms.

The ligand may be selected from anionic ligands, cationic ligands, affinity ligands and multimodal ligands.

The ligand or a portion of the ligand coupled to the derivatised cellulose nanofibers may be described by the formula:

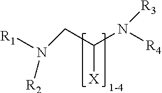

wherein
X independently for each occurrence is selected from H, OH or a C₁₋₃ group, and
R1, R2, R3 and R4 are independently selected from H, and a C₁₋₃ group,
wherein a C₃ group is straight or branched,
wherein a C₁₋₃ group comprises groups independently selected from OH, O—C₁₋₂, S—C₁₋₂, NH, NHR, NR₂,
wherein R is selected from H and a C₁₋₃ group, and wherein
the diamine functionality of the ligand or portion of the ligand is coupled to the derivatised cellulose nanofibers such that it generates at least one weak anion exchange group to an ionic capacity of 10-500 μmol/mL. The ligand or a portion of the ligand may be described by the formula above. The ligand comprises a diamine functionality generating at least one weak anion exchange group to an ionic capacity of 10-500 μmol/mL.

The diamine ligand can constitute part of a larger structure such as a polymer. In the ligand or the portion of the ligand comprising a diamine functionality generating at least one weak anion exchange group described by the formula above, the two amines may be separated by 2-4 carbon atoms, each amine group may be substituted by two R groups, which may be chosen from H and alkyl groups C₁₋₄ and that can be branched and/or also substituted by other groups such as hydroxyl, amines, ether and thio ether, these later being restricted to 3-8 atoms.

With such a ligand, an anion exchange chromatography medium is created. This may for example be used for purification of enveloped virus particles or extracellular vesicles, such as exosomes. Enveloped viruses are budding off from the host cells and have an outer lipid bilayer derived from the cell membrane containing viral glycoprotein. Inside the enveloped particle there is a protein capsid containing the viral genetic material. The envelope is critical for the infection of host cells (bind and fuse with host cell membrane) but is very sensitive to shear forces, salt, pH and detergents for example. Conditions during production and purification are important to retain infectivity of the virus and maximize the recovery of functional infectious virus. Examples of such enveloped viruses are DNA viruses, such as herpesvirus, oxvirus, hepadnavirus and asfarviridae; RNA viruses, such as flavivirus, alphavirus, togavirus, coronavirus, hepatitis D, orthomyxovirus, paramyxovirus, rhabdovirus, bunyavirus and filovirus; and retroviruses such as lentiviruses.

The support material is functionalized with ligands to an ionic capacity (number of charged functional groups per ml medium (μmol/ml)) of 10-500 μmol/mL, or in the range of 50-300 μmol/mL or 100-300 μmol/mL. No known affinity ligands exist for enveloped virus particles or exosomes. Development of affinity ligands for enveloped viruses is challenging due to a common requirement of harsh elution conditions that is likely to harm the virus. An ion exchange capture solution would enable milder elution conditions and would generate an improved process with higher recoveries.

The at least one weak anion exchange group may comprise multimodal weak anion-exchange groups, i.e. the anion-exchange group provides at least two different, but co-operative, sites which interact with the compound to be bound (i.e. the enveloped virus particle or exosome). For example, one of these sites may give an attractive type of charge-charge interaction between the ligand and the substance of interest. The other site may contribute to the binding by introducing a second local charge or by increasing the local amount of solvating water, which is impacting the binding capacity.

The weak anion exchange group may be positively charged or partially positively charged at a pH of 6-10.

Such positively charged or partially positively charged weak anion exchange group may attract an enveloped virus particle or exosome being negatively charged at neutral pH, such as lentivirus particles.

The weak anion exchange group may be positively charged or partially positively charged at a pH of 6-10 or, 6-9.5, 6-9 or 6-8.

Weak ionic exchange groups means that there is a gradient according to the pH from fully charged to not charged, having at PI a neutral charge (same amount of + and −). Strong anionic exchange groups, based on a quaternary amine, are on the contrary always charged. Almost all other anionic exchange groups, not based on a quaternary amine, are weak, i.e. the charge varies (and can be zero) within a reasonable range of pH used (such as e.g. pH 2-11).

The ligand may be selected from N,N,N′-triethylethylenediamine, diethylene-triamine, N,N′-dimethylethylenediamine, N-methylethylenediamine, 1,3-diaminopropane, 1,3-diamino-2-hydroxypropane, 2-methyl-1,3-propanediamine, N,N-diethylethylenediamine and diethylethylaminoethyl.

When the functionalised chromatography medium is provided with an anionic ligand, cationic ligand, or multimodal ligand an ionic capacity may be 10-500 μmol/mL.

The optimum ionic capacity being dependent on the ligand used.

The ligand may be an affinity ligand.

The affinity ligand may for example be an antibody, a recombinant protein that has been engineered to have affinity for a specific target, a peptide or smaller synthetic ligand, Protein A, Protein G, IMAC, Con A, Heparin, etc.

The affinity ligand may be coupled to the derivatised cellulose nanofibers in a ligand density (number of affinity ligands per mL of medium) of at least 150 nmol/mL.

The optimum ligand density being dependent on the target to be purified and on the size of the affinity ligand used. The affinity ligand density may be e.g. 150-1000 nmol/mL, or 200-800 nmol/mL.

The method may further comprise a step of blocking non-reacted crosslinking groups, such as divinylsulfone groups.

Blocking of non-reacted groups may be performed for example by thioglycerol or simply NaOH.

A functionalised chromatography medium with a ligand being an affinity ligand, as described above, may be used in affinity chromatography.

A functionalised chromatography medium with a ligand being an anionic ligand, cationic ligand or multimodal ligand, as described above, may be used in ion exchange chromatography.

According to another aspect there is provided a process of separating an analyte in a solution, the process comprising: obtaining a solution comprising an analyte; adding the solution to a functionalised chromatography medium provided with an anionic ligand, cationic ligand, or multimodal ligand, and produced as described above, in a binding buffer having a conductivity of 1.5-35.0 mS/cm; eluting the analyte from the chromatography medium by contacting the chromatography medium with an elution buffer having a conductivity of 20-105 mS/cm, and collecting the thus formed eluate containing the analyte. According to a third aspect there is provided a process of separating an analyte in a solution, the process comprising: obtaining a solution comprising an analyte; adding the solution to the functionalised chromatography medium provided with an affinity ligand, and produced as described above, in a binding buffer having a conductivity of 1.5-35.0 mS/cm; eluting the analyte from the chromatography medium by contacting the chromatography medium with an elution buffer having a conductivity of 20-105 mS/cm, and collecting the thus formed eluate containing the analyte.

The binding buffer may for example be a 20-50 mM TRIS buffer and the elution buffer may for example be 20-50 mM TRIS buffer 0.1-1.3M NaCl.

In one example when Lentivirus is being separated, the binding buffer may have a conductivity of around 20 mS/cm.

Elution may take place using an elution buffer having a conductivity of 20-105 mS/cm. This could be accomplished using an elution buffer comprising 0.13-1.3 M NaCl and using a pH gradient of 6.5-8.5.

In the processes described above, the analyte that is separated may be selected from mRNA, viruses, virus-like particles, plasmids, exosomes, and protein complexes. Such analytes typically have a size, such a diameter, of at least 10 nm, and may have a size of at least 20 nm. By contrast, monoclonal antibodies typically have a size of about 5 nm. An example of a protein complex is IgM. IgM may have a molecular weight of about 5 times that of a monoclonal antibody based on IgG.

### BRIEF DESCRIPTION OF THE DRAWINGS

FIG. 1 shows functionalisation of a cellulose acetate material using glycidol and divinyl sulfone (upper part of FIG. 1) and a new way of directly functionalising the cellulose acetate material with divinyl sulfone without using a glycidol extender (lower part of FIG. 1). Brackets indicate repeating moieties. “RC” stands for regenerated cellulose (in which the acetate group from the CA is hydrolysed).

FIGS. 2a-2c show the different steps in functionalising a cellulose acetate material with a ligand, H₂N—X, using divinyl sulfone without using a surface extender. The ligand being for example an antibody or DAX (N,N-diethylethylenediamine).

FIG. 2d shows the different steps in functionalising a cellulose acetate material with a DEAE ligand, using divinyl sulfone without using a surface extender.

FIG. 3 shows cellulose acetate functionalisation using DEAC (N,N-diethyl-aminoethyl chloride) and DAX (N,N-diethylethylenediamine), respectively without using a surface extender, an wherein non-reacted divinylsulfone groups are deactivated with thioglycerol.

FIG. 4 shows results of lentivirus purification using different DAX and DEAE functionalised fibrous matrix/membrane chromatography media without any extender.

### DETAILED DESCRIPTION

Cellulose acetate (CA) is the acetate ester of cellulose produced from cellulose via the process of acetylation. Electrospinning may be used to form CA nanofibers. A matrix or membrane of such CA nanofibers forms a fibrous matrix or membrane, which can be used as support material in chromatography. The cellulose acetate fibrous membrane may be a convection-based matrix, and may have a mean flow pore size of 0.1-2.0 μm and a cross-sectional diameter of 10-1000 nm. Such a fibrous material, hereinafter called fibro material, can be found in a HiTrap™ Fibro unit from Cytiva.

A convection-based chromatography matrix includes any matrix in which application of a hydraulic pressure difference between the inflow and outflow of the matrix forces perfusion of the matrix, achieving substantially convective transport of the substance(s) into the matrix or out of the matrix, very rapidly at a high flow rate.

The mean flow pore size of the membrane or matrix may be 0.1-2.0 μm, 0.1-1.8 μm, 0.1-1.6 μm, 0.1-1.4 μm, 0.1-1.2 μm, 0.1-1.0 μm, 0.1-0.8 μm, 0.1-0.6 μm, 0.1-0.4 μm, 0.1-0.2 μm, 0.2-2.0 μm, 0.4-2.0 μm, 0.6-2.0 μm, 0.8-2.0 μm, 1.0-2.0 μm, 1.2-2.0 μm, 1.4-2.0 μm, 1.6-2.0 μm, 1.8-2.0 μm, or 0.5-1.5 μm. Mean flow pore (MFP) size is an indicator of material flow characteristics, and is measured by capillary flow porometry, based on the displacement of a wetting liquid with a known surface tension from the sample pores by applying a gas at increasing pressure. The higher the MFP size, the larger the flow of liquid through the material at a given pressure. The mean flow pore size is calculated from the point at which 50% of the flow goes through a sample. Mean flow pore size thus corresponds to the pore size calculated at the pressure where the wet curve and the half-dry curve meet. In an alternative definition, the mean flow pore size of the present stationary phase may be seen as an effective pore size defined as the size of the largest sphere that is able to pass through the pore.

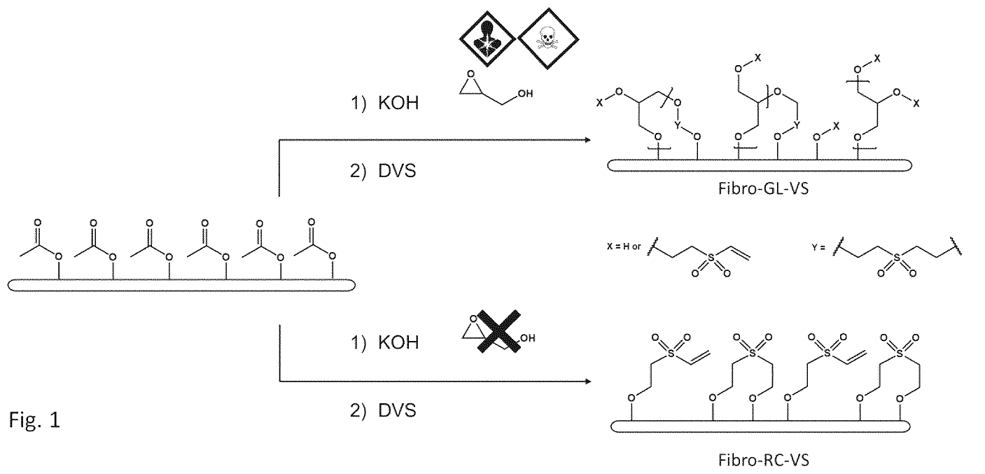

It is known in the art to functionalise cellulose acetate-based material using an extender group, such as glycidol, see FIG. 1 (upper part). The use of a glycidol extender together with divinyl sulfone has commonly been used for functionalization of CA, as it results in a satisfactory binding of protein A for mAbs applications. Glycidol is, however, a substance that is classified as carcinogenic, mutagenic, or toxic for reproduction (CMR) and as such its use should be decreased or avoided when possible.

Below is described a method of functionalising cellulose acetate-based fibrous material without using a glycidol extender group, see also FIG. 1 (lower part).

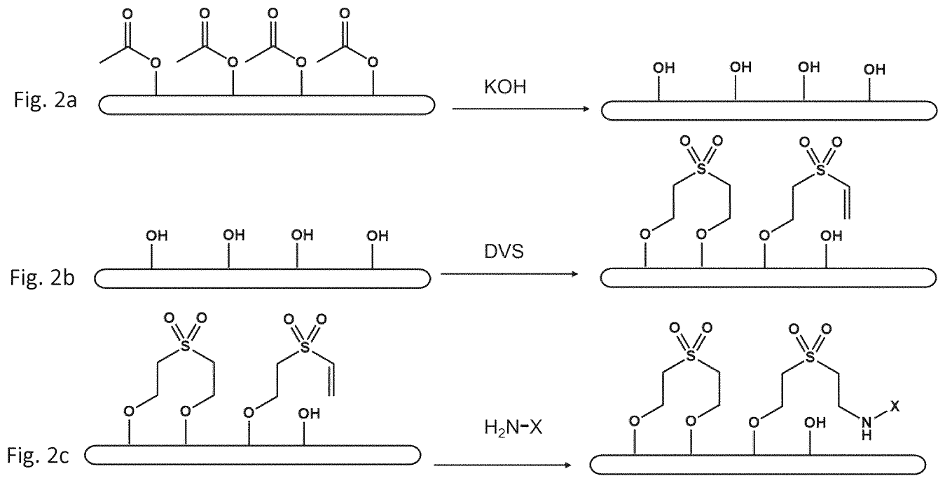

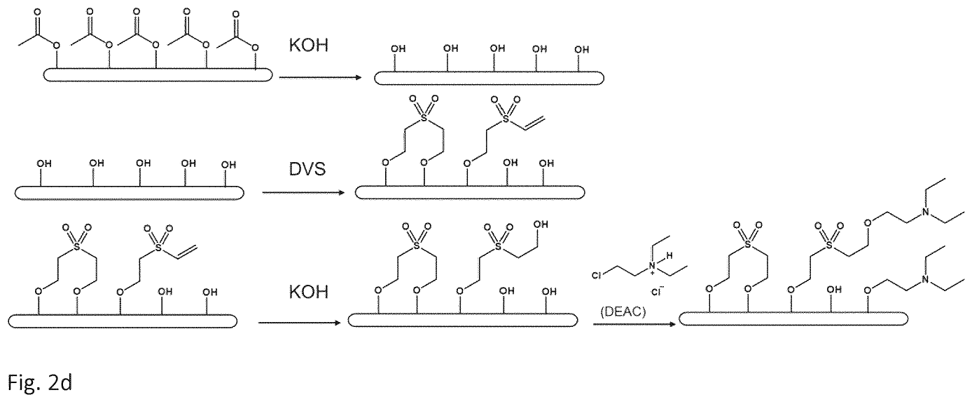

A substrate comprising cellulose acetate is provided and is hydrolysed by saponification, FIG. 2a, forming regenerated cellulose. Saponification is performed in aqueous basic conditions with or without a co-solvent such as EtOH. The pH used may be between 12-14, preferably around 12.7 (0.5 M OH—). The base of choice may be 0.5 M KOH. In one example potassium hydroxide (0.5 M) in a water/ethanol solution (2:1) is used and allowed to react at ambient temperature for at least 5 hours.

Thereafter, derivatisation of the regenerated cellulose with a cross-linker is made, FIG. 2b. Such a crosslinker may comprise at least two functional groups arranged to react with hydroxyl groups of the regenerated cellulose nanofibers, and may be selected from e.g. halide, acrylamide, epoxide, tosylate, a functional group comprising a double bound, such as vinyl, that can be activated, or any combination thereof. The functional groups may be selected from divinyl sulfone, bis acrylamide, butanediol diglycidyl ether, epichlorohydrin, allyl glycidyl ether, allyl bromide, 1, 4 di bromo butane, bismaleimide or any combination thereof.

In FIG. 2b and FIG. 2d, divinylsulfone is used as the crosslinker. Divinyl sulfone derivatisation may be obtained by addition of a hydroxyl group from the cellulose membrane to one of the vinyl groups of the divinyl sulfone under basic conditions. A portion of the second vinyl moieties reacts with other hydroxyl groups on the cellulose backbone to crosslink the fibres while the remaining vinyl sulfones are functionalised in a later step to effect binding. Concentration of the divinyl sulfone solution used may be within 0.5-4 mol/L, preferably in the range 1.5-2.5 mol/L. pH may be within 8.2-10, preferably within 8.5-9.5. In one example, the regenerated cellulose is reacted in a solution of Na₂CO₃, acetonitrile (C₂H₃N) and divinyl sulfone (CH₂═CH)₂SO₂ (or C₄H₆O₂S). In one example Na₂CO₃, (0.54 M) in a water/acetonitrile (C₂H₃N) (4:1) solution and divinyl sulfone is allowed to react with the regenerated cellulose at ambient temperature for at least 5 hours.

To the vinylsulfone derivatised cellulose nanofibers a ligand is coupled, FIG. 2c (H₂N—X), FIG. 2d (DEAE). The ligand may be anionic ligands, cationic ligands, affinity ligands or multimodal ligands.

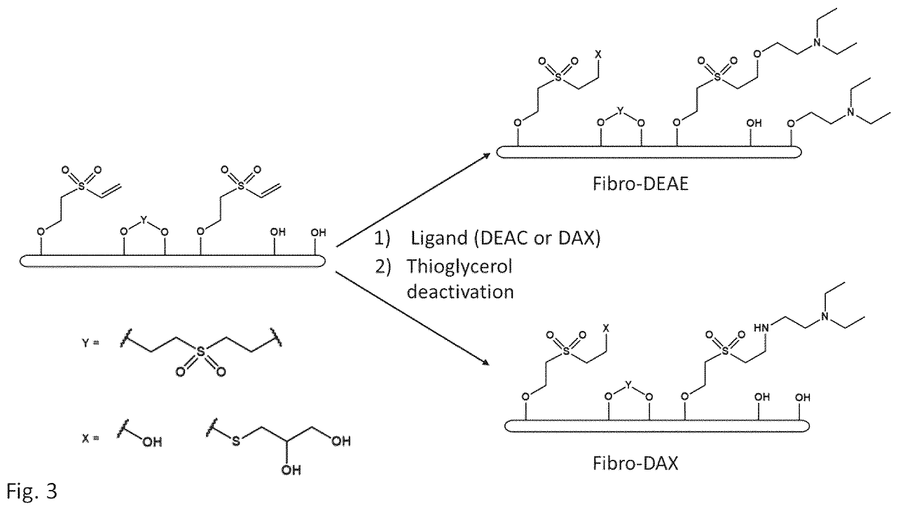

The ligand may be a diamine functionality generating at least one weak anion exchange group such as DEAE (diethylaminoethyl), FIG. 2d, FIG. 3 (upper part) and DAX (N,N-diethylethylenediamine), FIG. 2c, FIG. 3 (lower part).

DEAE is a known ligand in chromatography. Diamine ligands can be directly purchased as such, like DAX, but can as well be prepared in situ via the addition of alkyl amines having a leaving group that can be added to the support and the resulting amino resin can further react. DEAC ((2-chloroethyl) diethylamine) used for the preparation of DEAE resin is a good example of such a reagent

The direct coupling of polyamine ligands to the vinyl groups may be performed at a pH of 11-13 using for example a ligand solution having a concentration of 0.1-0.8 molar.

The above described functionalised support material, functionalised with e.g. DEAC or DAX, may be used in anion exchange chromatography and may for example be used for purification of enveloped virus particles or exosomes. The support material may be functionalised with ligands to an ionic capacity (number of charged functional groups per ml medium (μmol/ml)) of 10-500 μmol/mL. No known affinity ligands exist for these kind of enveloped virus particles or exosomes.

The ligand may alternatively be an affinity ligand, such as for example an antibody, a recombinant protein that has been engineered to have affinity for a specific target, a peptide or smaller synthetic ligand, FIG. 2c. The affinity ligands may be coupled with a cross-linker, such as vinyl groups, without using an extender group, to the solid support via the addition of nucleophilic groups such as amines or via thiols present on the ligand. The coupling conditions are similar to the ones used for DAX. For pH sensitive ligands the coupling is performed at a lower pH such as close to pH 11. For ligands containing free thiol groups the coupling can be performed at even lower pH such as 8.3-9.5, preferably around pH 9. Such functionalised support material may be used in affinity chromatography.

The method may further comprise a step of blocking non-reacted vinylsulfone derivatised groups, FIG. 3, by e.g. adding ethylene diamine (or 2-mercaptoethylamine hydrochloride).

In the experimental section below, specific and non-limiting examples of the production of functionalized support material and their use in chromatography are discussed.

### EXPERIMENTAL

### Lentivirus Feed Material

LVV (Lentiviral vector) was produced in HEK 293 suspension cell cultures (transient/Producer cell line) with an approximate cell density of 2*10⁶ cells/mL and a cell viability >90% at harvest point. All feeds were DNAse-treated and ≤0.45 μm normal flow filtered prior to chromatography. Feeds with a titer >5×10⁶ TU/ml or 5*10⁹ VP/mL and impurities ranging from 4000-11000 μg/mL for total protein and 200-1500 ng/ml for DNA were used. The final feed should be at pH 7.4-8.0 (adjust if necessary). The feed should be stored immediately at −80° C. in suitable aliquots for chromatography (recommended: 40 mL).

### Fibrous Matrix Material

A solution of cellulose acetate (CA), with a relative molecular mass of 29,000 g/mol, was dissolved in common solvents prior to electrospinning to produce fibres with diameters ranging between 300-600 nm. Optimised conditions for nanofibre production can be found in, for example, O. Hardick, et al, J. Mater. Sci. 46 (2011) 3890. Sheets of approximately 20 g/m² material were layered and subjected to a combined heating and pressure treatment.

35 strips (100×155 mm²) of the formed CA material were placed in between polypropylene gauze and loaded into a flow reactor. The strips were washed three times for 20 minutes with distilled water and then left to stand in the last water wash overnight.

The CA material was saponificated to form regenerated cellulose (RC). A solution of KOH (132 g) in water (3,149 L) was prepared in a suitable container. Ethanol (1.574 L) was added to the KOH solution during stirring. The basic ethanoic solution was added to the flow reactor. The recirculating pump was switched on and the mixture was recirculated for 6 h. After 6 h of recirculation, the pump was stopped, and the flow reactor was drained. The material was washed with 4×6 L distilled water for at least 20 min each time and then washed with 6 L of acetone (2×20 min) before leaving the material to air-dry in the flow reactor.

Thereafter, divinylsulfone derivatisation of the RC was made. In an 8 L beaker/container, distilled water (4.211 L) was added followed by Na₂CO₃ (316.1 g). The content was stirred until complete dissolution of the base. Acetonitrile (HPLC for gradient analysis; >99.9%; 1.258 L) was added and the mixture was stirred for 2 min before being loaded into the flow reactor. The recirculating pump was switched on and the mixture was recirculated for 2 min before adding the divinylsulfone portion (>99%, 1.350 L). The reaction mixture was recirculated for 6 h at room temperature. The reaction mixture was drained and the material was washed by recirculation of 1:1 water/acetone (6 L) at 24-26° C., 4 times for 20 minutes each time. The material was then rinsed by recirculation of distilled water (6 L), twice for 15 mins each time. The material was thereafter used.

### Coupling of a Ligand

To the fibrous matrix material produced as described above, a ligand was then coupled to the divinylsulfone derivatised cellulose nanofibers:
A) a ligand with a diamine functionality generating at least one weak anion exchange group to an ionic capacity of 10-500 μmol/mL, here exemplified with DEAE (DiEthylAminoEthyl) and DAX (N,N-Diethylethylenediamine).
B) an affinity ligand, here exemplified with an AVB antibody.

### DEAE (DiEthylAminoEthyl) Ligand

The following protocols were used for the DEAE functionalization:

### DEAE Coupling

Fibro-VS strips from above were washed with 150 ml DV20, 4 times in a polypropylene (PP) container to remove residual solvent Following this, 2 g KOH was dissolved in 25 ml deionised water and added to the Fibro-VS strips for 30 minutes. Thereafter, 1.9 ml of DEAC (2-(diethylamino)ethylchloride hydrochloride) (65%) together with 23 ml of DV20 were added. The PP container was sealed with parafilm and put on an orbital shaker (≈60 rpm). The reaction continued for 16 h at room temperature. Afterwards, the disks were washed with 150 ml DV20×6×20 min. Titration gave an ionic capacity of 113.3 μmol/ml.

A deactivation solution was prepared: Ethylenediaminetetraacetic acid, disodium dihydrate (EDTA*Na2*2H2O, 61 mg) and di-Sodium hydrogen phosphate dodecahydrate (Na₂HPO₄*12H₂O, 5.7 g) were added to deionized water (150 ml). After 5 minutes stirring thioglycerol (12 ml) was added and the pH adjusted to 8.3.

The Fibro-VS strips were suspended in the above deactivation solution and stirred for 16 hours at room temperature. Thereafter, the strips were washed with DV20 3 times, once with 1 M NaCl and 3 times with DV20. Each wash was performed with 150 ml of solution with a contact time of 20 minutes.

### DAX (N,N-Diethylethylenediamine) Ligand

Fibro VS strips from above were reacted with N,N-diethylethylenediamine to form a functionalized matrix with N,N-diethylethylenediamine groups, forming a Fibro DAX (diamino exchange) material. The following protocol was used for the functionalization: N,N-Diethylethylenediamine coupling solutions were formed:
1) 1.2% in water (V/V)
2) 3% in water (V/V)
   Fibro-VS strips were placed in a polypropylene (PP) container together with the respective coupling solution on an orbital shaker. The reaction was left for 16 hours, washed with 150 ml distilled water, and placed back on an orbital shaker for ^{˜0} 20 mins. The water washing process was repeated 5 times. Titration gave an ionic capacity of respectively 142 and 186 μmol/mL. The deactivation was performed following the procedure described above for Fibro DEAE.

### Antibody Ligand

About 20 mL AVB ligand (ligand to AAV (adeno-associated virus)) solution, 13 mg/ml, was placed in each of 4 VivaSpin filters (5000 D cut-off, Sartorius Stedim), and centrifuged for 30 mins at 4000 rpm. A NanoDrop spectrophotometer was calibrated using 13 mg/ml solution.

The spin filtered AVB solution was used to make up the immobilisation conditions shown in Table 1.

TABLE 1

| Conc. | Vol. | Vol. DI | Vol. | Total | Ligand |
|---|---|---|---|---|---|
| AVB | AVB | water | (NH₄)₂SO₄ | vol. | density |
| (mg/mL) | (mL) | (mL) | (mL) | (mL) | (mg/mL) |
| 20 | 7.1 | 0.9 | 17 | 25 | 8.5 |
| 10 | 3.5 | 6.5 | 17 | 25 | 4.9 |
| 5 | 1.8 | 6.2 | 17 | 25 | 3.8 |
| 4 | 1.4 | 6.6 | 17 | 25 | 3.6 |
| 3 | 0.8 | 7.2 | 17 | 25 | 2.9 |
| 2 | 0.6 | 7.4 | 17 | 25 | 1.8 |
| 1 | 0.3 | 7.7 | 17 | 25 | 0.9 |
| 0.5 | 0.1 | 7.9 | 17 | 25 | 0.5 |

The coupling buffer used was 3.0 M (NH₄)₂SO₄, 0.1 M NaHCO₃, pH 9.0. During the immobilisation, Fibro-VS strips prepared as above were left on an orbital shaker to immobilise overnight in different concentrations of AVB (see Table 1). After this time, supernatant was collected and strips washed 4× with distilled water for 20 mins each. Supernatant AVB concentration was measured using the NanoDrop spectrophotometer to determine the level of binding and ligand densities. Strips were then submerged in 30 m 300 mM ethanolamine blocking solution, pH 9, and left in orbital shaker for 1-2 hours. After this time, strips were washed with 2× distilled water for 20 mins each, followed by 2× alternating washes of PBS solution at pH=2 and pH=7.4, and then further washes with distilled water. Strips were stirred in 20% ethanol, 20% glycerol and 60% water.

The thickness of each strip was taken to calculate the volume of membrane (mL), and the mass of AVB immobilized (mg) was calculated using the concentration in supernatant after immobilization. From this the ligand density at each condition was calculated where variants were concentration in AVB.

### Anion Exchange Chromatography Using DEAE and DAX Functionalised Support Material

The above-described DEAE and DAX functionalized support materials were used as anion exchange chromatography media in the following anion exchange chromatography experiments when purifying lentivirus particles.

The support material was used in a Fibro HiTrap unit in an ÄKTA pure 150 chromatography system, using the following run conditions:
Buffer A1 (Running buffer): 50 mM Tris, pH 8.0
Buffer B1 (Elution buffer): 50 mM TRIS, pH 8.0, 1.3 M NaCl
CIP buffer (cleaning in place buffer): 1.0 M NaOH
Residence time: 2.4 sec (dynamic binding capacity (DBC) >10¹² VP/mL)
Pressure limit: a maximum delta-column pressure limit of 1.0 MPa (10 bar).
Approximate load range: 3*10¹¹ VP/3*10⁸ TU per device for Lentivirus at a residence time of 2.4 sec. However, typically ^{˜}20-200 ml of post-NFF (normal flow filtered) material can be loaded. As a general guide, loading amount should ideally 50-85% of the dynamic binding capacity of the unit to achieve the best recovery and purity. The actual loading amount is heavily dependent on the feed, not only the titre, HCP (host cell protein) and DNA content of the feed, but also the amount and size of any particulates.

Before adding the lentivirus sample, the sample pump lines were flushed, through to the waste outlet valve, with 100% Buffer A1 until the UV/conductivity stabilized and the Fibro unit was flushed with 100% Buffer A1 at 10 mL/min until the 280 nm UV and conductivity signals stabilized. Thereafter, the prime sample pump was flushed with Lentivirus feed using the outlet “sample pump waste”.

Table 2 below summarises the bind-elute protocol used.

TABLE 2

| Standard bind-elute | | | | Fraction |
|---|---|---|---|---|
| protocol phase | Flow | Volume | Inlet | collection |
| Equilibration | 10 ml/min | 20 mL | 100% A1 | off |
| Sample Application | 10 ml/min | variable | Sample pump | on |
| Column Wash | 10 ml/min | 10 mL | 100% A1 | off |
| Elution | 10 ml/min | 10 mL | 50% B1 | on |
| Column Wash | 10 ml/min | 10 mL | 100% B1 | off |
| CIP | 5 ml/min | 7 mL | 100% B2 | off |
| Column Wash | 10 ml/min | 10 mL | 100% B1 | off |
| Equilibration | 10 ml/min | 20 mL | 100% A1 | off |

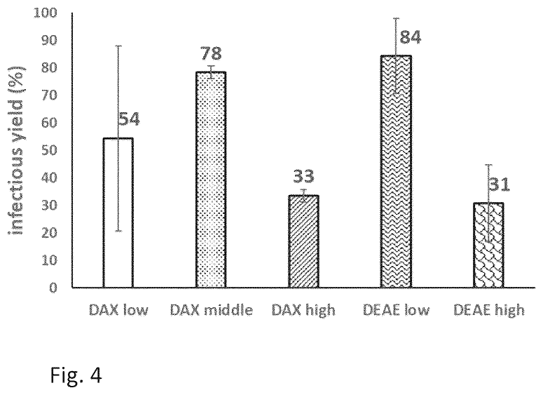

DAX and DEAE functionalised membranes without glycidol with different ligand densities were tested for their ability to recover infectious virus. Different ligand densities were investigated with the method described above (Table 2). The results are summarised in FIG. 4. The DAX low prototype had an ionic capacity (IC) of 41 μmol/mL, DAX middle has an IC of 186 μmol/mL, DAX high had an IC of 214 μmol/mL, DEAE low has an IC of 113 μmol/mL and DEAE high had an IC of 247 μmol/mL. The infectious yield was 54% (STD 34) for DAX low, 78% (STD 2) for DAX middle, 33% (STD 2) for DAX high, 84% (STD 14) for DEAE low and 31% (STD 14) for DEAE high. The results pointing to an optimum between 100-200 μmol/mL for both ligands. When using optimal conditions and membrane, an infectious yield of around 80% can be achieved with either ligand-DAX or DEAE.

Some binding of lentivirus particles will happen within the specified ionic capacity range of 10-500 μmol/mL, since it is an electrostatic interaction. An optimum ionic capacity value is connected with the need to have enough ligand to ensure binding but not too high ionic capacity such that the binding is too hard and cause a decrease in recovery. It is likely possible that the optimum ionic capacity is strongly dependent on the support material used (ligand density by surface of contact). For fibro the optimum IC seems to be around 100-250 μmol/mL. Capacity of the membrane was estimated by determining the total particles that need to be loaded to achieve 10% breakthrough (also known as DBC or QB10% capacity) of at least 1.00E+ 12 particles/mL would be preferred for most applications for ligand densities of 10-500 μmol/mL.

The results above are shown for the enveloped virus Lentivirus. Similar results are obtainable also with other enveloped virus types, such as DNA viruses and RNA viruses and exosomes.

Affinity Chromatography Using Support Material with AVB Ligand

The above-described functionalised support material with AVB ligand was used in affinity chromatography. A MiniPEEK column (polyether ether ketone), Cytiva, housing a single stack of 10-layer Fibro AVB membrane, 0.343 μmol/g, with a membrane volume of 19-20 μl was used.
Running buffer: 20 mM Tris, 500 mM, NaCl 0.001% Pluronic F-68, pH 8.5
Elution buffer: 100 mM NaOAc, 500 mM NaCl, 0.001% Pluronic F-68, pH 2.5
Neutralization buffer: 200 mM Tris, 500 mM, NaCl 0.001% Pluronic F-68, pH 10.5

After equilibration with running buffer in the MiniPEEK column, approximately 1.2E13 capsids of AAV-5 (approximately 1E12 capsids/mL) were loaded at 0.5 mL/min. Flow-through fractions of 0.6 mL were collected. The membrane was then washed with 10 ml of running buffer and eluted with 6 mL of elution buffer, each collected (separately) in a single tube. The elution fraction was neutralized to pH 7.5-8.5 by adding 1 ml of neutralization buffer.

AAV titre in each fraction was quantified using AAV-5 titration ELISA kit (Progen), following the manufacturer's instructions. The percentage of breakthrough (BT) for each fraction was calculated.

Capacity of the membrane was estimated by determining the total capsids that need to be loaded to achieve 10% breakthrough (also known as DBC or QB10% capacity) for the volume of the MiniPEEK device (taking in consideration the specific thickness of each membrane). This value was then corrected for 1 mL membrane volume, assuming a linear scale up.

AAV titre in each fraction was quantified using AAV-5 titration ELISA kit (Progen), following the manufacturer's instructions. Elution fractions containing >10% of the most concentrated fraction were considered when calculating recovery.

Samples and standards were diluted in MiliQ H2O using a Nimbus liquid handler. Protein concentration in each fraction was quantified using Pierce™ Coomassie Plus (Bradford) Assay Kit (Thermo), following the manufacturer's instructions.

Samples and standards were diluted using the Nimbus liquid handler. DNA concentration in each fraction was quantified using Quantit Picogreen dsDNA kit (Thermo), following the manufacturer's instructions.

In Table 3 below is shown estimated capacities of the membrane provided with different ligand densities, ranging from 143 to 714 nmol/mL, through determination of the total capsids that need to be loaded to achieve 10% breakthrough, QB10% capacity.

TABLE 3

| Ligand density | Capacity |
|---|---|
| (nmol/mL) | (capsids/mL) |
| 143 | <1E+13 |
| 250 | 1E+14 |
| 286 | >4E+13 |
| 714 | 1E+14 |

A QB10 of at least 1.00E+13 capsids/ml would be preferred for most applications. As can be seen from Table 3, a ligand density below 250 nmol/mL here resulted in a capacity lower than 1.00 E+13.

1. A chromatography medium, comprising
a matrix of cellulose-based nanofibers, the nanofibers optionally being crosslinked to one another, and
a ligand, coupled to the matrix without any intermediate extender group.

2. The chromatography medium of claim 1, wherein the matrix comprises crosslinks between said nanofibers, provided by a crosslinking agent selected from the group consisting of divinyl sulfone, bis acrylamide, butanediol diglycidyl ether, epichlorohydrin, allyl glycidyl ether, allyl bromide, 1,4-dibromo butane and bismaleimide.

3. The chromatography medium of claim 1, wherein the ligand is coupled to the nanofibers of the matrix via a linking group comprising less than 10 repeating moieties, or via a linking group that contains no more than 20 atoms.

4. The chromatography medium of claim 1, wherein the ligand is selected from anionic ligands, cationic ligands, affinity ligands and multimodal ligands.

5. The chromatography medium of claim 4, wherein the ligand or a portion of the ligand described by the formula: 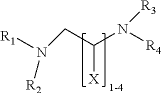
wherein
X independently for each occurrence is selected from H, OH or a C₁₋₃ group, and
R1, R2, R3 and R4 are independently selected from H, and a C₁₋₃ group,
wherein a C₃ group is straight or branched,
wherein a C₁₋₃ group comprises groups independently selected from OH, O—C₁₋₂, S—C₁₋₂, NH, NHR, NR₂,
wherein R is selected from H and a C₁₋₃ group, and wherein
the diamine functionality of the ligand or portion of the ligand is coupled to the derivatised cellulose nanofibers such that it generates at least one weak anion exchange group to an ionic capacity of 10-500 μmol/mL.

6. The chromatography medium of claim 5, wherein the ligand is selected from N,N,N′-triethylethylenediamine, diethylenetriamine, N,N′-dimethylethylenediamine, N-methylethylenediamine, 1,3-diaminopropane, 1,3-diamino-2-hydroxypropane, 2-methyl-1,3-propanediamine, N,N-diethylethylenediamine and diethylethylaminoethyl.

7. The chromatography medium of claim 4, wherein the functionalised chromatography medium is provided with said anionic ligand, cationic ligand, or multimodal ligand to an ionic capacity of 10-500 μmol/mL.

8. The chromatography medium of claim 4, wherein the ligand is an affinity ligand.

9. The chromatography medium of claim 8, wherein the chromatography medium has a ligand density of at least 150 nmol/mL.

10. The chromatography medium of claim 1, wherein the matrix allows convective flow of a fluid through the matrix.

11. The chromatography medium of claim 1, wherein the matrix has a mean flow pore size in the range of from 0.1-2.0 μm.

12. The chromatography medium of claim 1, wherein the ligand is coupled to the nanofibers of the matrix via a linking group selected from a vinyl sulfone moiety and an alkyne or allyl derivative.

13. A method of preparing a functionalised chromatography medium, which method comprises:
(i) providing a substrate comprising cellulose acetate,
(ii) forming a fibrous matrix/membrane spun of nanofibers from the substrate,
(iii) saponification of the nanofibers to form regenerated cellulose nanofibers,
(iv) derivatisation of the regenerated cellulose nanofibers with a cross-linker,
(v) coupling of a ligand to the derivatised cellulose nanofibers,
wherein the preparation of the functionalised chromatography medium does not comprise any surface extender.

14. The method of claim 13, wherein the cross-linker comprises at least two functional groups arranged to react with hydroxyl groups of the regenerated cellulose nanofibers.

15. The method of claim 14, wherein the functional groups are selected from, halide, acrylamide, epoxide, tosylate, a functional group comprising a double or triple bond that is or can be activated, or any combination thereof.

16. The method of claim 15, wherein the functional groups are selected from divinyl sulfone, bis acrylamide, butanediol diglycidyl ether, epichlorohydrin, allyl glycidyl ether, allyl bromide, 1, 4 di bromo butane, bismaleimide or any combination thereof.

17. The method of claim 14, wherein the crosslinker is divinylsulfone.

18. The method of claim 17, wherein the divinylsulfone derivatised regenerated cellulose nanofiber matrix/membrane has a vinylsulfone content in the range of 200-1600 μmol/g, such as 200-1000 μmol/g.

19. The method of claim 14, wherein the ligand is selected from anionic ligands, cationic ligands, affinity ligands and multimodal ligands.

20. The method of claim 19, wherein the ligand or a portion of the ligand coupled to the derivatised cellulose nanofibers is described by the formula: 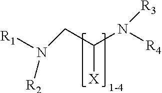
wherein X is selected from H, OH or a C₁₋₃ group, and
R1, R2, R3 and R4 are independently selected from H, and a C₁₋₃ group,
wherein a C₃ group is straight or branched,
wherein a C₁₋₃ group comprises groups independently selected from OH, O—C₁₋₂, S—C₁₋₂, NH, NHR, NR₂,
wherein R is selected from H and a C₁₋₃ group, and wherein
the diamine functionality of the ligand or portion of the ligand is coupled to the derivatised cellulose nanofibers such that it generates at least one weak anion exchange group to an ionic capacity of 10-500 μmol/mL.

21. The method of claim 20, wherein the ligand is selected from N,N,N′-triethylethylenediamine, diethylenetriamine, N,N′-dimethylethylenediamine, N-methylethylenediamine, 1,3-diaminopropane, 1,3-diamino-2-hydroxypropane, 2-methyl-1,3-propanediamine, N,N-diethylethylenediamine and diethylethylaminoethyl.

22. The method of claim 19, wherein the functionalised chromatography medium is provided with an anionic ligand, cationic ligand, or multimodal ligand to an ionic capacity of 10-500 μmol/mL.

23. The method of claim 19, wherein the ligand is an affinity ligand.

24. The method of claim 23, wherein the affinity ligand is coupled to the derivatised cellulose nanofibers in a ligand density of at least 150 nmol/mL.

25. A process of separating an analyte in a solution, the process comprising:
obtaining a solution comprising an analyte,
adding the solution to a chromatography medium provided with an anionic ligand, cationic ligand, or multimodal ligand according to claim 4, in a binding buffer having a conductivity of 1.5-35.0 mS/cm,
eluting the analyte from the chromatography medium by contacting the chromatography medium with an elution buffer having a conductivity of 20-105 mS/cm, and collecting the thus formed eluate containing the analyte.

26. A process of separating an analyte in a solution, the process comprising:
obtaining a solution comprising an analyte,
adding the solution to the functionalised chromatography medium provided with an affinity ligand according to claim 4, in a binding buffer having a conductivity of 1.5-35.0 mS/cm,
eluting the analyte from the chromatography medium by contacting the chromatography medium with an elution buffer having a conductivity of 20-105 mS/cm, and collecting the thus formed eluate containing the analyte.

27. The process of claim 25, wherein the analyte is selected from the group consisting of mRNA, viruses or virus-like particles, plasmids, exosomes, and protein complexes.

28. The process of claim 27, wherein analyte is selected from the group consisting of mRNA, viruses, virus-like particles, plasmids, and exosomes.

29. The process of claim 27, wherein analyte is an enveloped virus, such as a lentivirus.

30. Use of a chromatography medium according to claim 1, for separation of an analyte selected from the group consisting of mRNA, viruses, virus-like particles, plasmids, and extracellular vesicles, and preferably viruses, such as viral vectors.
